(19) United States
(12) Patent Application Publication
(10) Pub. No.: US 2015/0259088 A1
(43) Pub. Date: Sep. 17, 2015

(54) DEVICE AND METHOD FOR ORIENTING OBJECTS

(71) Applicant: Charlotte Anna Maria LIEDI, (US)

(72) Inventor: Charlotte Anna Maria Liedl, Lana (IT)

(21) Appl. No.: 14/422,022

(22) PCT Filed: Sep. 19, 2013
(86) PCT No.: PCT/IB2013/058659

§ 371 Date: Feb. 17, 2015

(30) Foreign Application Priority Data
Oct. 31, 2012 (IT) MO2012A000266

(51) Int. Cl. B65B 35/58; G06K 9/00; G06K 9/32; B65B 57/00

(52) U.S. Cl. CPC B65B 35/58; B65B 57/00; G06K 9/00624; G06K 9/3208

(57) ABSTRACT

A device for orienting objects in which a main axis (S) can be identified and comprising: first rotation means (11, 12), configured to bring about the rotation of an object (P) around a first axis (X); second rotation means (21), configured to bring about the rotation of an object (P) around a second axis (Y) perpendicular to the first axis (X); an optical detection device (31, 32), configured to capture images and/or a video of the object (P) during the rotation around the first axis (X); control means (50), configured to control the actuation of the first rotation means (11, 12) and of the second rotation means (21) and to receive and process the images and/or videos captured by the optical detection device (31, 32); said control means (50) being further configured to: recognize, during the rotation of the object (P) around the first axis (X), a first position in which a main axis (S) of the object (P) lies in a given plane of orientation (A); recognize, during the rotation of the object (P) around the first axis (X), a second position in which the object (P) assumes a pre-established angular position relative to the first rotation axis (X).

The present invention relates to a device for orienting objects, in particular fruit or vegetables with a spheroidal or oblong shape.

The invention has useful application in fruit and vegetable packaging lines, and in particular in packaging lines that envisage depositing the products inside flat trays and/or crates.

Packaging in flat trays and/or crates is usually restricted to high quality products, which undergo precise control processes that select only the products free of surface defects and endowed with substantially regular and uniform dimensional and morphological characteristics.

In order that the consumer can appreciate the quality of the packaged products, it is important for the products themselves to be deposited with a common orientation inside the trays or crates. In the case of apples, for example, it is very important that they be deposited with the surface portion of the most intense colour turned up and with the stems oriented substantially along the same direction.

At present, this type of orientation of products is performed manually, with a large use of labour. The operations are consequently rather laborious and costly.

There also exist some devices that carry out orientation procedures which are more or less automatic, but these are rather complex, bulky devices that can be installed along packaging lines only at the cost of considerable structural complications. The known devices, moreover, are not particularly effective or precise.

The object of the present invention is to offer a device for orienting objects which enables an object to be oriented along a desired direction rapidly and effectively.

One advantage of the device according to the present invention is that it has very modest overall dimensions, and can thus be easily installed along packaging lines which are already operating.

Another advantage of the device according to the present invention is that of being extremely accurate and reliable.

Another advantage of the device according to the present invention is that it requires no manual intervention during operation.

Additional features and advantages of the present invention will be better apparent from the detailed description that follows of one embodiment of the invention in question, illustrated by way of non-restrictive example in the appended figures in which:

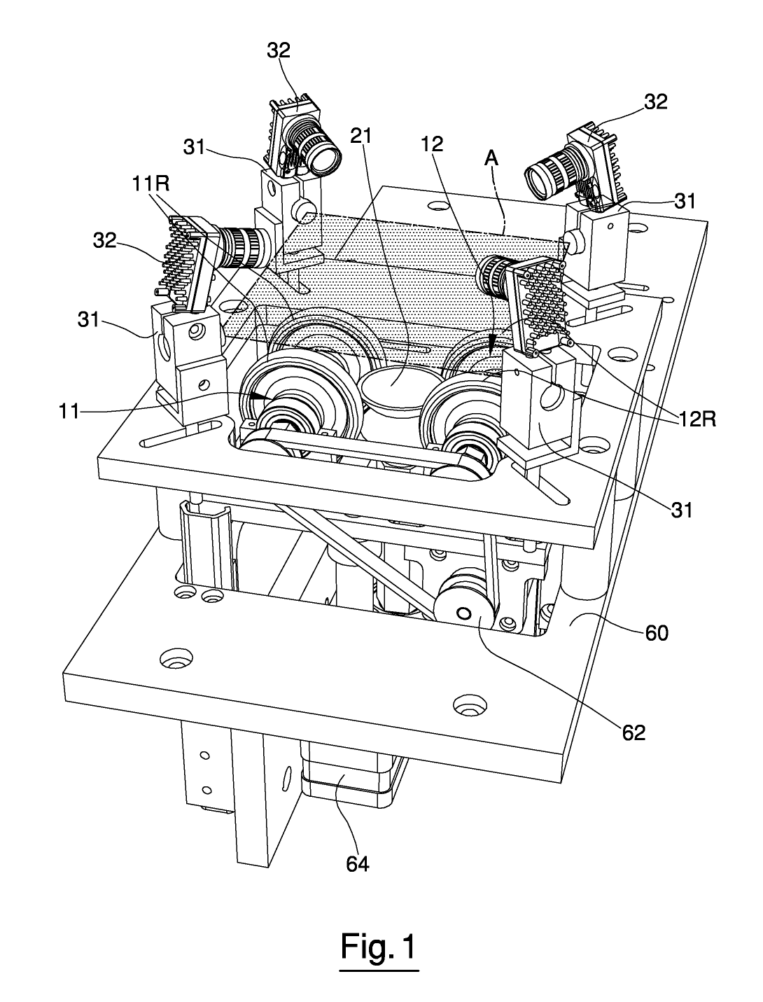

FIG. 1 shows an axonometric view of the device according to the present invention;

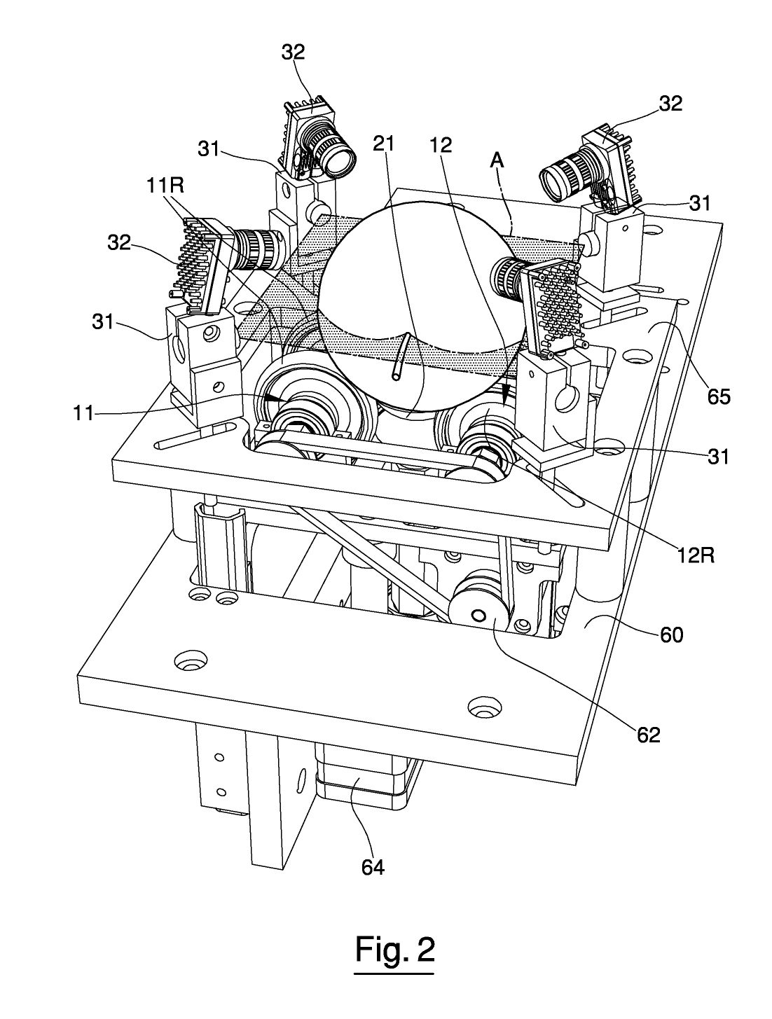

FIG. 2 shows an object (P), represented by an apple, placed on the device of FIG. 1;

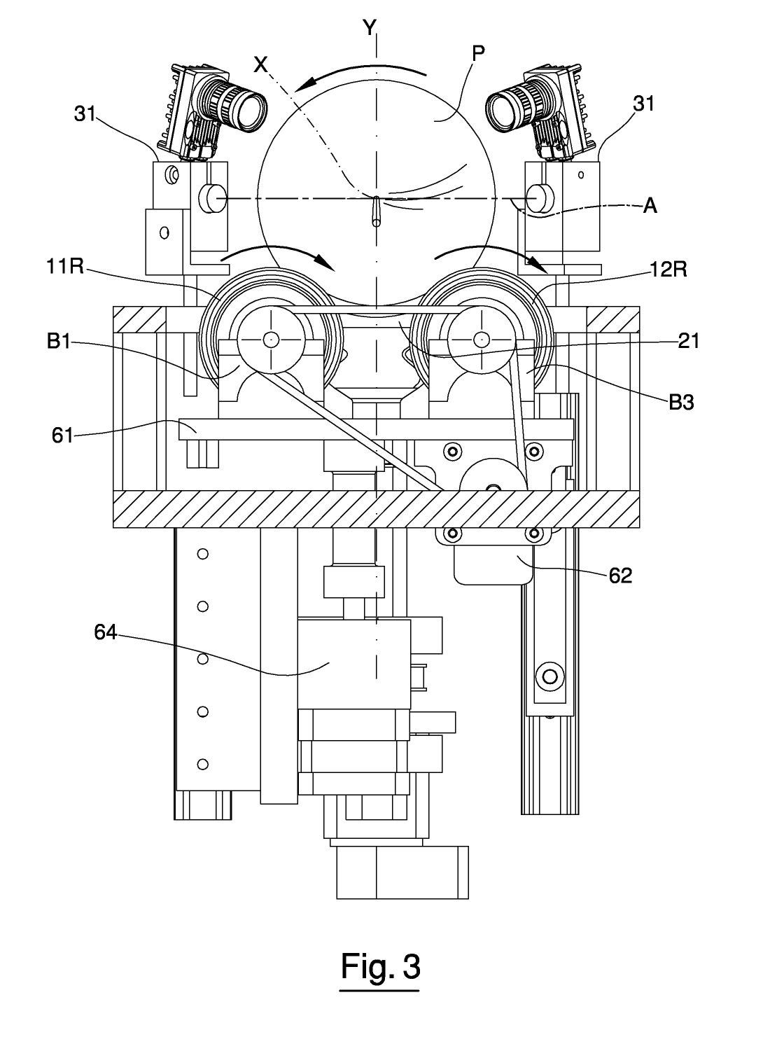

FIG. 3 shows a front view of the device of FIG. 2;

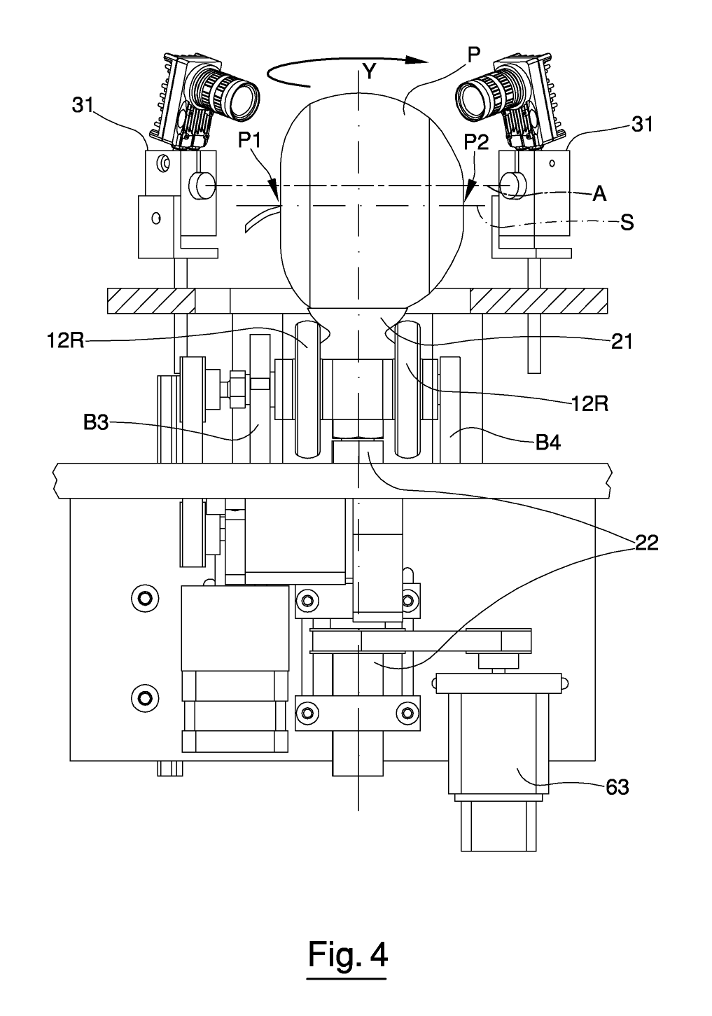

FIG. 4 shows a side view of the device of FIG. 2;

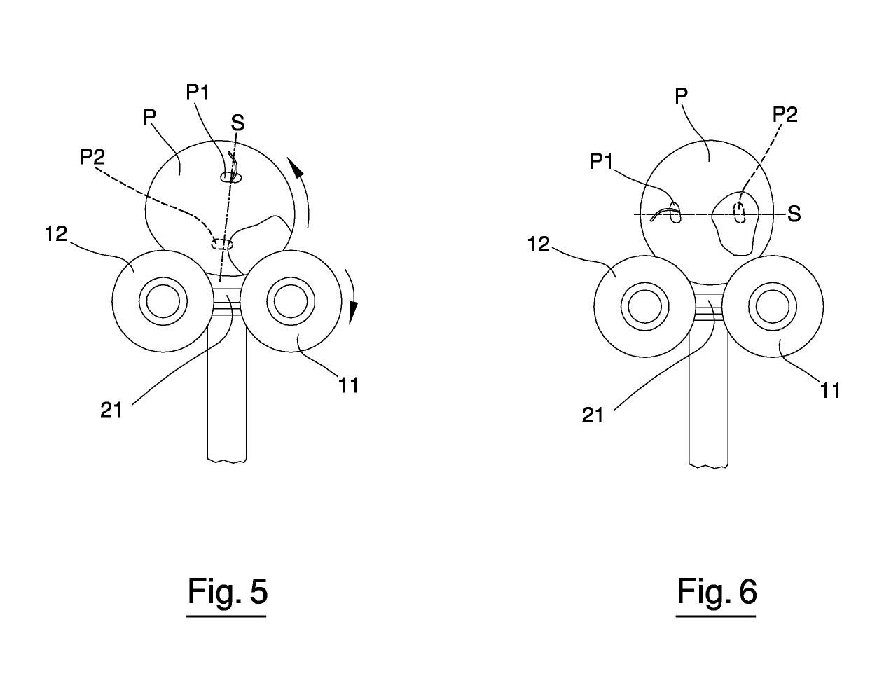

FIGS. 5 to 10 show in sequence the steps of orienting a product (P) represented by an apple;

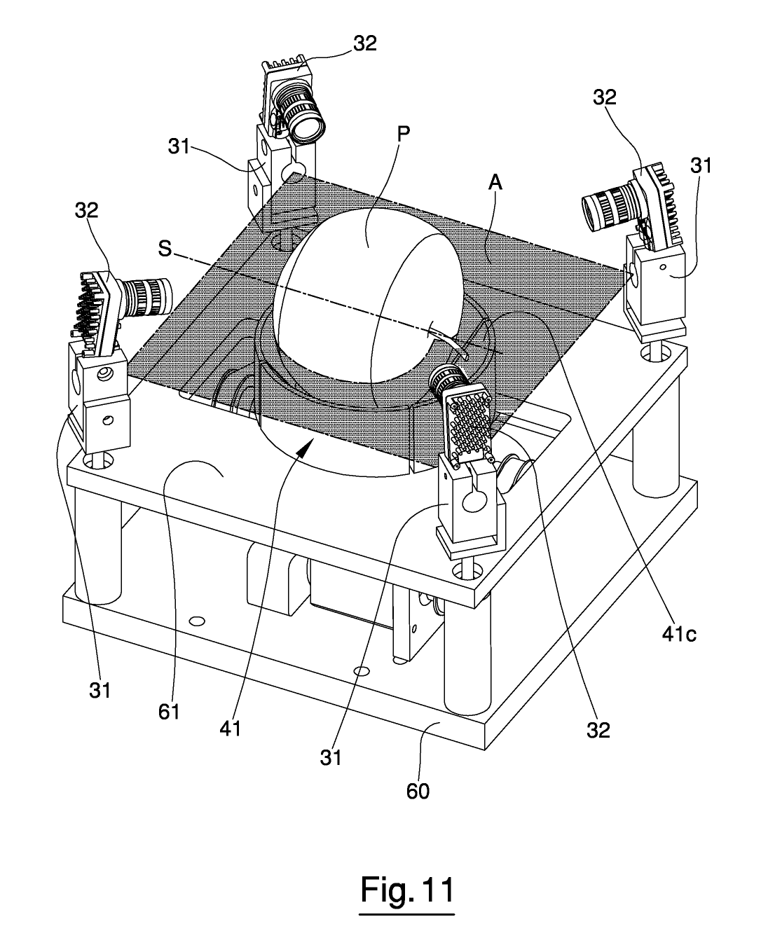

FIG. 11 shows a second embodiment of the device according to the present invention;

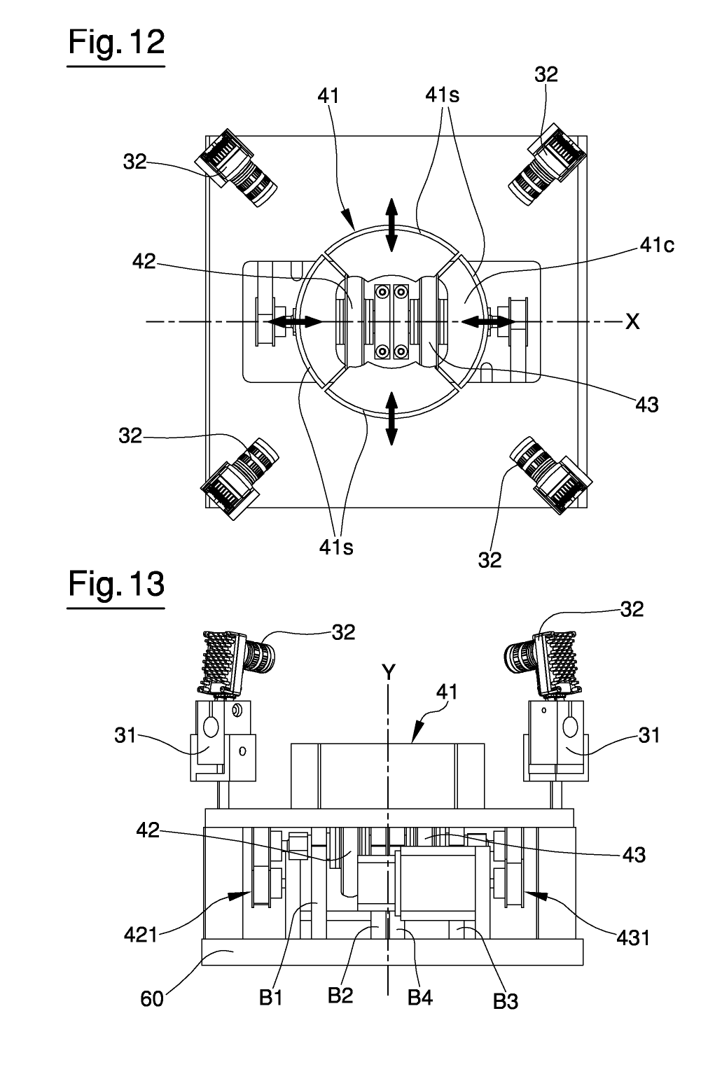

FIGS. 12 and 13 respectively show a view from above and a side view of the device of FIG. 11.

The object (P) on which the device according to the present invention operates can be of a different shape and size. In general, it is possible to identify, for each object (P), a main axis (S) whose orientation in space defines the orientation in space of the object (P).

In the appended figures the object (P) consists of an apple.

The apple has a stem (P1) and a calyx (P2) situated substantially in a position opposite the stem (P1). In the case of the apple, the main axis (S) can be identified with an axis that passes through the area of the stem (P1) and of the calyx (P2). This main axis (S) is thus taken as a reference to define the orientation of the apple in space. In an analogous manner, considering the different morphological conformations, it is possible to identify a main axis (S) for other products of a spheroidal or oblong shape. The device comprises rotation means (11, 12, 21, 41, 42, 43), configured to bring about the rotation of the object (P) around a first axis (X). The first axis (X) is preferably disposed horizontally. The first axis (X) lies in a plane of orientation (A) which, preferably, is likewise disposed horizontally. The rotation means (11, 12, 21, 41, 42, 43) are also configured to bring about the rotation of an object (P) around a second axis (Y) perpendicular to the first axis (X). The second axis (Y) is preferably perpendicular to the plane of orientation (A).

In a first embodiment of the device, the rotation means (11, 12, 21, 41, 42, 43) comprise first rotation means (11, 12), structured so as to support a resting object (P). Preferably, the first rotation means (11, 12) comprise at least a roller (11) that can be driven in rotation around an axis parallel to the first axis (X). A second support element, located in a position alongside the first roller (11), allows a product (P) to rest supported on the first roller (11). Preferably, the second support element is in the form of a second roller (12) that can be driven in rotation around an axis parallel to the first axis (X). A product (P) can thus be disposed so as to rest on the two rollers (11, 12) which are positioned side by side and also perform the function of containing any shifts of the product (P) in a direction transversal to the first axis (X). The rollers (11, 12) could both be motorized so as to rotate simultaneously in the same direction of rotation, or else one roller could be motorized and the other one idle. In both cases, the rotation of the rollers (11, 12) brings about the rotation of the product (P) around the first axis (X).

As can be seen in FIG. 1, each roller (11, 12) preferably comprises a pair of wheels (11R, 12R) intended to come into contact with the product (P). The wheels (11R, 12R) also perform the function of containing the product (P) with respect to direct shifts along the first axis (X).

Given the irregular shape of the objects (P) the device is mainly intended for, during the rotation of the object (P) around the first axis (X), the main axis (S) changes its orientation in space.

In the first embodiment of the device, the rotation means (11, 12, 21, 41, 42, 43) further comprise second rotation means (21), configured to bring about the rotation of an object (P) around a second axis (Y) perpendicular to the first axis (X). The second axis (Y) is preferably perpendicular to the plane of orientation (A).

Preferably, the second rotation means (21) comprise a support (21), consisting for example of a cup-shaped body made of a flexible material in order to protect the object (P) against impacts and damage. The support (21), preferably a suction cup, can be driven in rotation around the second axis (Y) by means of a rotary actuator, which is not illustrated in detail as it is well known to the person skilled in the art. The first and the second rotation means are mobile relative to each other, along the second axis (Y), between a first position in which the support (21) is in a lowered position, below the first rotation means (11, 12), and the object (P) is supported by the first rotation means (11, 12), and a second position, in which the support (21) is in a raised position, above the first rotation means (11, 12), and supports an object (P) above the first rotation means (11, 12). In the preferred embodiment of the device, the support (21) does not move parallel to the second axis (Y), whereas the first rotation means (11, 12), and in particular the rollers (11, 12), translate parallel to the second axis (Y) relative to the support (21).

From a purely kinematic viewpoint, the rotations of the object (P) are determined in the following manner. The rotations around the first axis (X) are obtained by disposing the first rotation means (11, 12) in the first position, in which the rollers (11, 12) are in a raised position, above the second rotation means (21) (FIG. 3, 5, 6, 9, 10). Driving one or both of the rollers (11, 12) in rotation brings about the rotation of the object (P) around the first axis (X). The rotations around the second axis (Y) are obtained by disposing the first rotation means (11, 12) in the second position, in which the rollers (11, 12) are in a lowered position, below the second rotation means (21) (FIGS. 4, 7, 8). The object (P) is raised by the first rotation means (11, 12) and supported only by the second rotation means (21), in particular by the support (21). Driving the support (21) in rotation around the second axis (Y) brings about a corresponding rotation of the object (P).

In a second embodiment of the device, shown in FIG. 12, the rotation means (11, 12, 21, 41, 42, 43) comprise a fixed cradle (41), structured so as to contain the movements of the object (P) in the plane of orientation (A). The fixed cradle (41) is open at the top and has a concave surface (41c) intended to delimit, at least laterally, a housing for an object (P). Facing each other on the bottom of the fixed cradle (41) there are a first (42) and a second roller (43), which are concentric relative to the first axis (X). The first and the second roller (42, 43) are motorized independently of each other, so that they can be driven in concordant or discordant rotation and at an equal or different speed. The first and the second roller (42, 43) partially project from the concave surface of the fixed cradle (41). In this manner, an object (P) placed inside the fixed cradle (41) will be in contact with at least one of the rollers and with the concave surface of the fixed cradle (41). If the rollers (42, 43) are driven in concordant rotation, the object (P) will rest laterally in contact with the concave surface (41c) of the fixed cradle (41) and be brought into rotation around the first axis (X) in an opposite direction relative to the rollers (42, 43). If the rollers (42,43) are driven in discordant rotation, the object (P) will rest all the same in contact with the concave surface (41c) of the fixed cradle (41), but will be brought into rotation around the second axis (Y).

The device according to the present invention further comprises an optical detection device (31, 32), configured to capture images and/or a video of the object (P) during the rotation around the first axis (X).

In a preferred embodiment, the optical detection device comprises a profile detector or profilometer (31, 32). The profile detector (31, 32) preferably comprises a light source (31), which projects a beam of light, preferably laser, distributed over a plane. The light source is low power, so as not to require the use of personal protection devices and not to damage the object (P). The light source is positioned in such a way that the laser beam strikes the surface of the object (P) on a profile of the object (P) which lies in the plane of orientation (A). Preferably, the profile detector (31, 32) comprises a plurality of light sources (31) positioned in such a way as to be able to completely illuminate a profile of the object (P) around the second axis (Y). In particular, four light sources (31) are provided and located in pre-established positions around the second axis (Y). As schematically illustrated in FIG. 2, the laser beam projected by the light source (31) strikes the surface of the object (P) and illuminates a line that follows the profile of the object (P) in the plane of orientation of the laser beam itself, which, as mentioned above, preferably coincides with the plane of orientation (A). The profilometer (31, 32) further comprises a device (32) for capturing videos, for example a television camera. The camera (32) is trained in such a way as to film the surface of the object (P) in an area which comprises the profile illuminated by the light source (31). In a preferred embodiment of the device, the device for capturing videos (32) consists of a group of four cameras (32), trained in such a way as to film the entire profile illuminated by the light source (31), all around the object (P).

Control means (50), comprising a data processing unit, are connected to the rotation means (11, 12, 21, . . . ) and to the optical detection device (31, 32).

The control means (50) are configured to control the actuation of the first rotation means (11, 12) and of the second rotation means (21) and to receive and process the images and/or videos captured by the optical detection device (31, 32).

In particular, the control means (50) are configured to recognize, during the rotation of the object (P) around the first axis (X), a first position in which a main axis (S) of the object (P) lies in the plane of orientation (A). In greater detail, the control means (50) receive, in real time, during the rotation of the object (P) around the first axis (X), images of the surface of the object (P) picked up by the camera (32), in particular images of the profile of the object (P) in the plane of orientation (A) illuminated by the light source (31). Via a recognition algorithm they are provided with, the control means (50) are capable of detecting a change in the profile of the object (P) in the plane of orientation (A) during the rotation of the object (P) around the first axis (X). By means of this algorithm, the control means (50) are moreover capable of recognizing when a pre-established area of the surface of the object (P), having a profile of a pre-established shape, is located in the plane of orientation (A). This pre-established of the surface of the object (P) is the area through which the main axis (S) of the object passes.

Depending on the type of object (P) one wishes to obtain the orientation of, the area through which the main axis (S) passes, that is, the area which must be recognized, can have different shapes and hence profiles. In the case of apples, the areas through which the main axis (S) passes are the area of the stem (P1) and the area of the calyx (P2). As schematically illustrated in FIG. 1, the surface profile in these two areas is substantially defined by a curved line that has a cusp. The control means (50) are capable of recognizing, along the profile of the apple illuminated by the light source (31) in the plane of orientation (A), the presence of these cusps, and consequently of deriving the information that, at the moment of recognition of the cusp, the main axis (S) of the apple is lying in the plane of orientation (A).

A first step in the process of orienting the object (P) thus involves setting the object (P) in rotation around the first axis (X) via the first motor means (11, 12) (FIG. 4). During the rotation of the object (P) around the first axis (X), the main axis (S) changes its orientation in space. The object (P) is made to continue rotating around the first axis (X) until the main axis (S) of the object (P) is lying in the plane of orientation (A) (FIG. 5). When the main axis (S) is lying in the plane of orientation (A), the control means (50) will stop the first rotation means (11, 12) so that the object (P) will stop in a first position in which, precisely, the main axis (S) is lying in the plane of orientation (A).

By means of the recognition algorithm, the control means (50) are also capable of measuring the angle of inclination of the main axis (S) of the product (P) relative to the first axis (X). After the main axis (S) has been brought into the plane of orientation (A), the control means (50) then trigger the activation of the second rotation means (21) so as to rotate the object (P) around the second rotation axis (Y) in order to orient the main axis (S) parallel to the first rotation axis (X) in the plane of orientation (A). The rotation around the second axis (Y) is equal to the angle between the main axis (S) of the product (P) and the first axis (X) as measured by the control means (50). In the event that the object (P) consists of an apple or another fruit, the recognition algorithm is also designed to recognize the position of the stem and thus to bring about a rotation around the second axis (Y) in such a way as to orient the stem on the desired side.

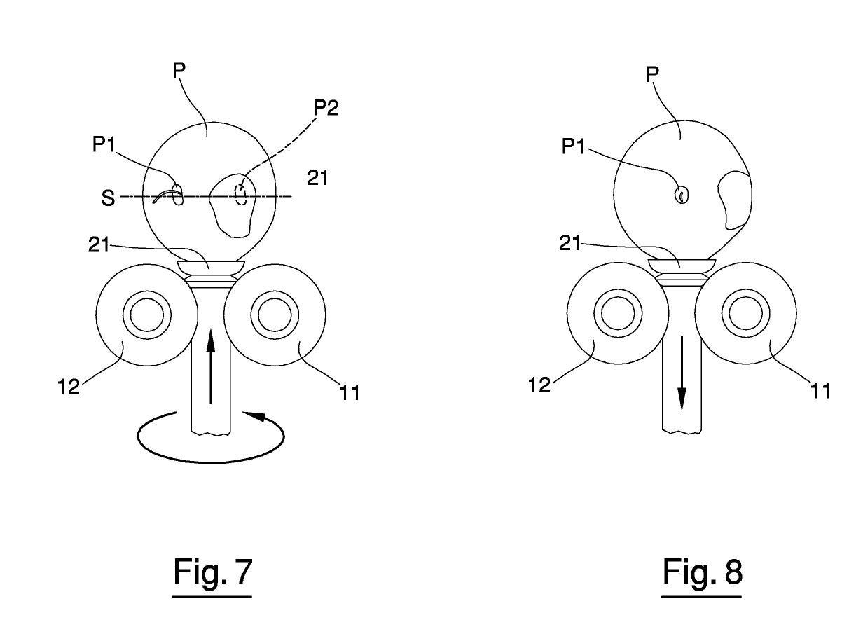

In particular, the control means (50) cause the first and second rotation means to move into the second position (FIG. 6), in which the support (21) is in the raised position relative to the first rotation means (11, 12) and in particular relative to the rollers (11, 12). In this second position the object (P) is raised by the first rotation means (11, 12) and supported by the support (21). Subsequently, the control means (50) cause the support (21) to rotate around the second axis (Y) by an angle which disposes the object (P) so that the main axis (S) thereof is parallel to the first axis (X) (FIG. 7).

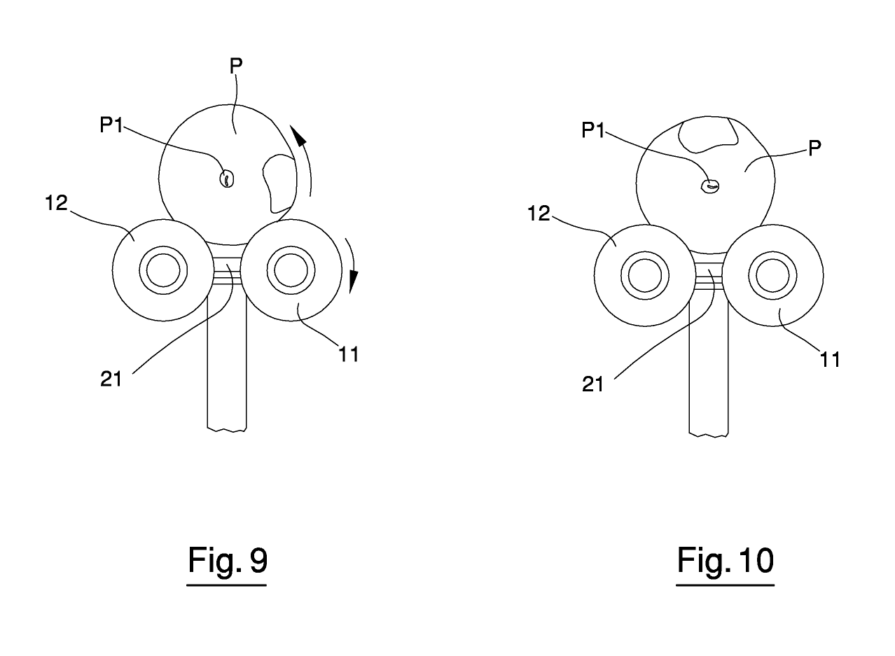

Once the main axis (S) of the object (P) has been oriented parallel to the first axis (X), the control unit (50) again disposes the first and second rotation means in the first position (FIG. 8), where the object (P) is supported by the first rotation means (11, 12). The first rotation means (11, 12) are again actuated so as to bring about a rotation of the object (P) around the first rotation axis (X) (FIG. 9).

The control means (50) are configured to recognize, during the rotation of the object (P) around the first rotation axis (X), a second position in which the object (P) assumes a pre-established angular position relative to the first rotation axis (X). In the case of an apple, this pre-established angular position could be, for example, the one in which the typical surface area with the most intense colour is turned up. In the case of different objects (P), the pre-established angular position could be defined in a different manner.

In this phase of the process as well, the control means (50) receive, in real time, during the rotation of the object (P) around the first axis (X), images of the surface of the object (P) picked up by the camera (32). The recognition algorithm the control means (50) are provided with enables them to recognize the presence and position of a particular area of the surface of the object (P)—in the case of apples, the surface area with the most intense colour. As soon as that surface area is disposed in the pre-established angular position, the control means bring the rotation of the object (P) to a halt and the orientation process ends (FIG. 10).

The object (P) can thus be picked up in the orientation reached and deposited in the destination container or tray.

The necessity of recognizing a pre-established angular position around the first rotation axis (X) might not exist, however, for example in the event that the object (P) has a uniform surface.

From a constructive viewpoint, the device according to the present invention is extremely simple and compact.

In the first embodiment, which can be seen in FIG. 1, the device comprises a support structure (60), with which the first rotation means (11, 12) and the second rotation means (21) are associated.

Preferably, the rollers (11, 12) of the first rotation means (11, 12) are associated with a plate (61). Each roller is supported by end supports (B1, B2, B3, B4), which ensure the possibility of it rotating around its axis. The supports (B1, B2, B3, B4) project from the plate (61) perpendicular to the first axis (X) and the plane of orientation (A). A first rotary actuator (62) is associated with the plate (61) and is kinematically connected to the rollers (11, 12), for example by means of a belt.

The support (21) of the second rotation means (21) is associated with the support structure (60) and is located in an intermediate position relative to the two rollers (11, 12) of the first rotation means. A second rotary actuator (63) is associated with the support structure (60) in order to bring about the rotation of the support (21) around the second axis (Y). The support (21) is associated with a rod (22), which is connected to the second rotary actuator by means of a belt.

The plate (61) with which the rollers (11, 12) of the first rotation means (11, 12) are associated can be moved parallel to the second axis (Y) relative to the support (21) by means of a linear actuator (64) connected to the support structure (60). The plate (61) is movable between an upper position, in which the rollers (11, 12) are above the support (21) and an object (P) can be supported by the rollers (11, 12), and a lower position, in which the rollers (11, 12) are below the support (21) which supports the object (P). When passing from the upper position to the lower position, the rollers (11, 12) deposit the object (P) on the support (21); conversely, when passing from the lower position to the upper position the rollers (11, 12) pick up the object (P) from the support (21).

The light sources (31) are also associated with the support structure (60). In particular, the light sources (31) are associated with the plate (61). Each of the cameras (32) is located above a light source (31).

In the second embodiment, which can be seen in FIGS. 11, 12, 13, the device comprises a support structure (60), associated with which there are two rotary actuators (421, 431) connected respectively to the first roller (42) and to the second roller (43) by means of a belt drive. Each of the rollers (42, 43) is rotatably supported around an axis parallel to the first axis (X) by means of respective supports (B1, B2, B3, B4) solidly joined to the support structure (60). The light sources (31) are also associated with the support structure (60). In particular, the light sources (31) are associated with the plate (61). Each of the cameras (32) is located above a light source (31).

Preferably, the fixed cradle (41) is divided into sectors (41s), which can be moved in a radial direction relative to the second axis (Y) by means of actuators not illustrated in detail. The movement of the sectors (41s) enables the fixed cradle (41) to be adapted to objects (P) of different sizes. The device according to the present invention provides important advantages.

Firstly, it enables a desired orientation of the object (P) to be obtained in a totally automatic manner. The orientation obtained is moreover very accurate and controllable.

Given its compact dimensions, the device according to the present invention can be easily placed in line with or alongside a line feeding the objects (P). A transfer device, not illustrated, can be configured to transfer the objects (P) from the feed line to the orientation device. The same transfer device, or a different device, can be configured to transfer the oriented objects (P) from the orientation device to a release position, for example on a tray or in a box for packaging.

1. A device for orienting objects in which a main axis (S) can be identified, characterized in that it comprises: rotation means (11, 12, 21, 41, 42, 43), configured to bring about the rotation of an object (P) around a first axis (X); an optical detection device (31, 32), configured to capture images and/or a video of the object (P) during the rotation around the first axis (X); control means (50), configured to control the actuation of the rotation means (11, 12, 21, 41, 42, 43) and to receive and process the images and/or videos captured by the optical detection device (31,32); said control means (50) being further configured to:
recognize, during the rotation of the object (P) around the first axis (X), a first position in which a main axis (S) of the object (P) lies in a given plane of orientation (A).

2. The device according to claim 1, wherein said control means (50) are configured to recognize, during the rotation of the object (P) around the first rotation axis (X), a second position in which the object (P) assumes a pre-established angular position relative to the first rotation axis (X).

3. The device according to claim 1, wherein the optical detection device (31, 32) comprises a profile detector (31, 32), the control means (50) being configured to recognize at least one area of the surface of the object (P) in which the profile exhibits a given conformation.

4. The device according to claim 3, wherein the profile detector (31, 32) is positioned in such a way as to detect a profile of the object (P) lying in the plane of orientation (A).

5. The device according to claim 4, wherein: the control means (50) are configured to receive, in real time, during the rotation of the object (P) around the first axis (X), the images of the profile of the object (P) in the plane of orientation (A); the control means are provided with a recognition algorithm by means of which they are capable of detecting the change in the profile of the object (P) in the plane of orientation (A) during the rotation of the object (P) around the first axis (X); by means of said recognition algorithm the control means (50) are further capable of recognizing when a pre-established area of the surface of the object (P), whose profile is illuminated by the light source (31), comes to lie in the plane of orientation (A) during the rotation of the object (P) around the first axis (X).

6. The device according to claim 1, wherein the optical detection device (31, 32) comprises a video capture device (32), the control means (50) being configured to recognize at least a given area of the surface of the object (P) having pre-established characteristics.

7. The device according to claim 6, wherein: the control means (50) are configured to receive, in real time, during the rotation of the object (P) around the first axis (X), the images of the surface of the object (P) picked up by the video capture device (32); the control means (50) are provided with a recognition algorithm by means of which they are capable of recognizing the presence and position of a particular area of the surface of the object (P).

8. The device according to claim 1, comprising first rotation means (11, 12) structured so as to support an object (P).

9. The device according to claim 1, wherein the first rotation means (11, 12) comprise at least a roller (11) that can be driven in rotation around an axis parallel to the first axis (X).

10. The device according to claim 9, wherein the first rotation means (11, 12) comprise a second roller (12) that can be driven in rotation around an axis parallel to the first axis (X).

11. The device according to claim 1, comprising second rotation means (21) provided with a support (21) that can be driven in rotation around the second axis (Y).

12. The device according to claim 1, wherein the first and the second rotation means are mobile relative to each other, along the second axis (Y), between a first position, in which the second rotation means (21) are in a lowered position, below the first rotation means (11, 12), and the object (P) is supported by the first rotation means (11, 12), and a second position, in which the second rotation means (21) are in a raised position, above the first rotation means (11, 12), and support an object (P) above the first rotation means (11, 12).

13. The device according to claim 1, comprising: a fixed cradle (41), structured so as to contain the movements of the object (P) in the plane of orientation (A), said fixed cradle (41) being open at the top and having a concave surface (41c) intended to delimit, at least laterally, a housing for an object (P); a first (42) and a second roller (43), which are concentric relative to the first axis (X) and project from the bottom of the fixed cradle (41) and are motorized independently of each other.

14. A method for orienting an object, comprising the following steps:
bringing about the rotation of an object (P) around a first axis (X);
capturing images and/or a video of the object (P) during the rotation around the first axis (X);
recognizing, during the rotation of the object (P) around the first axis (X), a first position wherein a main axis (S) of the object (P) lies in a given plane of orientation (A);
stopping the object (P) in the first position;
bringing about the rotation of the object (P) around a second rotation axis (Y) perpendicular to the plane of orientation (A) in such a way as to orient the main axis (S) parallel to the first rotation axis (X) in the plane of orientation (A);
again driving the first rotation means (11, 12) so as to bring about the rotation of the object (P) around the first rotation axis (X);
recognizing, during the rotation of the object (P) around the first rotation axis (X), a second position wherein the object (P) assumes a given angular position relative to the first rotation axis (X);
stopping the object (P) in the second position.

15. The method according to claim 14, wherein the step of capturing images and/or a video of the object (P) during the rotation around the first axis (X) comprises a step of detecting a profile of the object (P) in the plane of orientation (A).

16. The method according to claim 15, wherein the step of recognizing, during the rotation of the object (P) around the first axis (X), a first position in which a main axis (S) of the object (P) lies in a given plane of orientation (A), comprises a step of detecting the change in the profile of the object (P) in the plane of orientation (A) during the rotation of the object (P) around the first axis (X) and recognizing when a pre-established area of the surface of the object (P), having a profile of a pre-established shape, comes to lie in the plane of orientation (A).
